(19) United States
(12) Patent Application Publication
(10) Pub. No.: US 2015/0363654 A1
(43) Pub. Date: Dec. 17, 2015

(54) VISION-BASED WET ROAD SURFACE DETECTION USING MIRRORED AND REAL IMAGES

(71) Applicant: GM GLOBAL TECHNOLOGY OPERATIONS LLC, Detroit, MI (US)

(72) Inventors: QINGRONG ZHAO, MADISON HEIGHTS, MI (US); WENDE ZHANG, TROY, MI (US); JINSONG WANG, TROY, MI (US); BAKHTIAR BRIAN LITKOUHI, WASHINGTON, MI (US)

(21) Appl. No.: 14/302,605

(22) Filed: Jun. 12, 2014

(51) Int. Cl. G06K 9/00; G06K 9/62; G06T 7/40

(52) U.S. Cl. CPC G06K 9/00805; G06T 7/40; G06K 9/6202; G06K 9/6267

(57) ABSTRACT

A method for determining a wet road surface condition on a road. An image exterior of the vehicle is captured by an image capture device. A real object and a virtual object are detected in the captured image. A feature point is identified on the real object and on the virtual object. A potential virtual object associated with the real object is identified on a ground surface of the road in the captured image. The feature point detected on the real object is compared with the feature point detected on the virtual object. A determination is made whether the ground surface includes a mirror effect reflective surface in response to the feature point detected on the real object matching the feature point detected on the virtual object. A wet driving surface indicating signal is generated in response to the determination that the ground surface includes a mirror effect reflective surface.

### BACKGROUND OF INVENTION

An embodiment relates generally to detection of a wet road surface using reflective surfaces.

Precipitation on a driving surface causes several different issues for a vehicle. For example, water on a road reduces the coefficient of friction between the tires of the vehicle and the surface of the road resulting in vehicle stability issues. Typically, a system or subsystem of the vehicle senses for precipitation on the road utilizing some sensing operation which occurs when the precipitation is already negatively impacting the vehicle operation such as detecting wheel slip. Under such circumstances, the precipitation is already affecting the vehicle (e.g., wheel slip), and therefore, any reaction at this point becomes reactive. Proactive approach would be to know of the wet surface condition ahead of time as opposed in order to have such systems active which can prevent loss of control due to wet surfaces.

### SUMMARY OF INVENTION

An advantage of an embodiment is the detection of water on a road using a vision-based imaging device. The technique described herein requires no excitations from the vehicle or driver for initiating a determination of whether water or precipitation is present. Rather, a real object is detected in the captured image and a virtual object is detected on a ground surface in the captured image. A feature point is identified on the real object and the virtual object. The feature point identified on the real object and the virtual object are compared for determining whether the real object matches the virtual object. In addition, either the real object or the virtual object may be inverted so that a more direct comparison made be performed on the real object and the virtual object now located at a same position and orientation.

An embodiment contemplates a method for determining a wet road surface condition for a vehicle driving on a road. An image exterior of the vehicle is captured by an image capture device. A real object in the captured image is detected. A feature point on the real object is identified in the captured image. A potential virtual object associated with the real object is identified on a ground surface of the road in the captured image. A feature point on the virtual object is identified in the captured image. The feature point detected on the real object is compared with the feature point detected on the virtual object. A determination is made that the ground surface includes a mirror effect reflective surface in response to the feature point detected on the real object matching the feature point detected on the virtual object. A wet driving surface indicating signal is generated in response to the determination that the ground surface includes a mirror effect reflective surface.

### BRIEF DESCRIPTION OF DRAWINGS

FIG. 1a is a perspective view of a scene captured by a camera of a wet surface with still water.

FIG. 1b is an exemplary illustration of light reflection on still water.

FIG. 2a is a perspective view of a scene captured by a camera of a dry surface.

FIG. 2b is an exemplary illustration of light reflection and scattering on a dry surface.

FIG. 3 illustrates a block diagram of a wet road surface detection system.

FIG. 4 is an exemplary pictorial illustration of a virtual object on a wet road surface captured by a vehicle mounted camera.

FIG. 5 is an exemplary illustration of feature points matching between real object image and virtual object image.

FIG. 6 is an exemplary illustration of feature points matching utilizing an inverted object.

### DETAILED DESCRIPTION

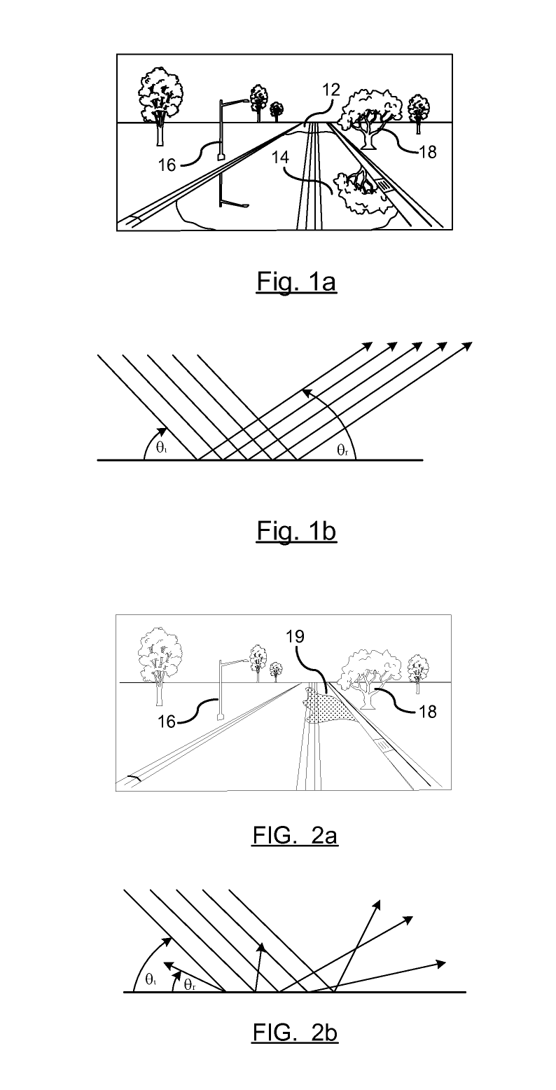

There is shown in FIG. 1, a vehicle traveling along a vehicle road 12. Precipitation 14 is shown disposed on the vehicle road 12 and is often displaced by the vehicle tires as the vehicle tires rotate over the wet vehicle road 12. It is often advantageous to know beforehand when the vehicle will be traveling along a wet vehicle road 12 so that issues resulting from precipitation, such as loss of traction or engine degradation resulting from water entering exterior air intake vents can be negated or at least mitigated.

Precipitation 14 on the vehicle road 12 can result in a reduction of traction when driving on the wet road surface. The precipitation 14 disposed on the vehicle road 12 lowers the coefficient of friction between the vehicle tires and the vehicle road 12. As a result, traction between the vehicle tires and the vehicle road 12 is lowered. Loss of traction can be mitigated by warning the driver to lower the vehicle speed to one that is conducive to the environmental conditions; actuating automatic application of the vehicle brake using a very low braking force to minimize the precipitation formed on the braking surfaces of the braking components; deactivation or restricting the activation of cruise control functionality while precipitation is detected; or notification to the driver to maintain a greater stopping distance to a lead vehicle.

As shown in FIG. 1a, water is disposed on the road and objects such as a tree 16 and a light pole 18 are seen in the reflective surface generated by the precipitation 14 in the form of still water on the vehicle road 12. The still water on the vehicle road 14 functions as a mirror-type surface which projects a reflection. A light reflection on the road surface, particularly a smooth surface where the water is still, will have an incident light angle that is substantially equal to the reflected light angle as shown in FIG. 1b. Therefore, a camera capturing an image through the reflective surface of the still water will capture light rays that have an incident light angle equal to a reflective light angle.

FIG. 2a illustrates a vehicle driven on a dry road having no precipitation on the road of travel. As shown, no precipitation exists on the vehicle road 12. Shadows 19 may be cast by objects such as the tree 18; however, shadows do not generate a reflective mirror surface. As shown in FIG. 2b, the reflected light rays are diffused once the incident light rays bounce off the non-mirrored surface. As a result, the reflected light rays are scattered and the angles of reflection are not equal to the angles of incidence as shown in FIG. 1b.

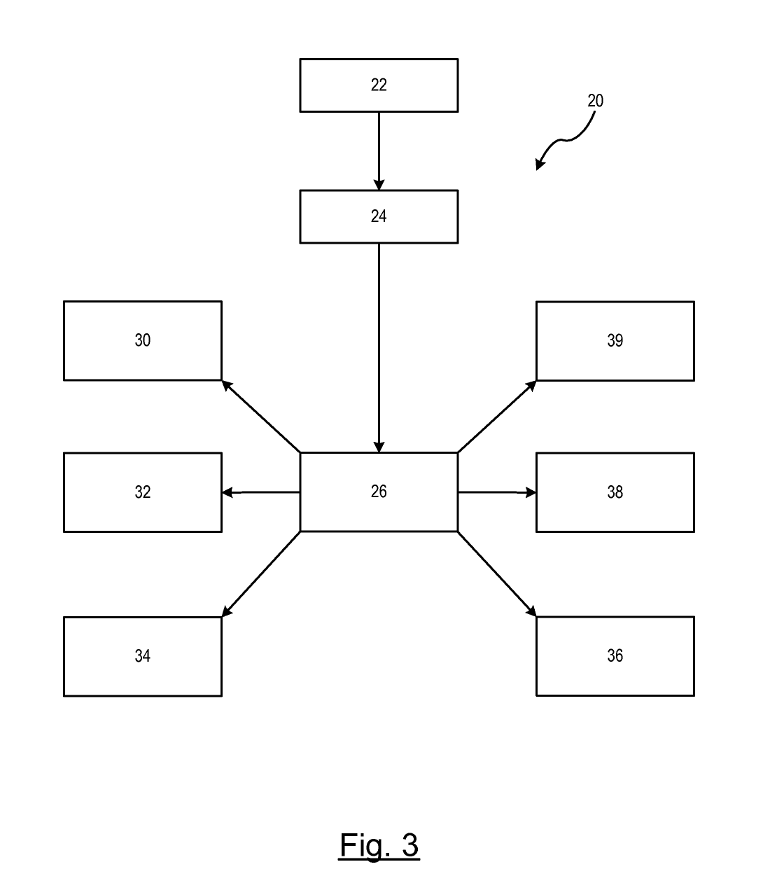

FIG. 3 illustrates a block diagram of a wet road surface detection system 20. A vehicle-based image capture device 22 is mounted on the vehicle for capturing images forward of the vehicle. The image device 22 may include, but is not limited to, a camera for capturing images of the road. The function of the image capture device 22 is to capture an image that includes objects above the road and additionally the road itself for detecting a presence of water on the road of travel. The images captured by the vehicle-based image capture device 22 are analyzed for detecting water therein.

A processor 24 processes the images captured by the image capture device 22. The processor 24 analyzes reflection properties of the road of travel for determining whether water is present on the road surface.

The processor 24 may be coupled to one or more controllers 26 for initiating or actuating a control action if precipitation is found to be on the road surface. One or more countermeasures may be actuated for mitigating the effect that the precipitation may have on the operation of the vehicle.

The controller 26 may be part of the vehicle subsystem or may be used to enable a vehicle subsystem for countering the effects of the water. For example, in response to a determination that the road is wet, the controller 26 may enable an electrical or electro-hydraulic braking system 30 where a braking strategy is readied in the event that traction loss occurs. In addition to preparing a braking strategy, the braking system may autonomously apply a light braking force, without awareness to the driver, to remove precipitation from the vehicle brakes once the vehicle enters the precipitation. Removal of precipitation build-up from the wheels and brakes maintains an expected coefficient of friction between the vehicle brake actuators and the braking surface of the wheels when braking by the driver is manually applied.

The controller 26 may control a traction control system 32 which distributes power individually to each respective wheel for reducing wheel slip by a respective wheel when precipitation is detected on the road surface.

The controller 26 may control a cruise control system 34 which can deactivate cruise control or restrict the activation of cruise control when precipitation is detected on the road surface.

The controller 26 may control a driver information system 36 for providing warnings to the driver of the vehicle concerning precipitation that is detected on the vehicle road. Such a warning actuated by the controller 26 may alert the driver to the approaching precipitation on the road surface and may recommend that the driver lower the vehicle speed to a speed that is conducive to the current environmental conditions, or the controller 26 may actuate a warning to maintain a safe driving distance to the vehicle forward of the driven vehicle. It should be understood that the controller 26, as described herein, may include one or more controllers that control an individual function or may control a combination of functions.

The controller 26 may further control the actuation of automatically opening and closing air baffles 38 for preventing water ingestion into an engine of the vehicle. Under such conditions, the controller 26 automatically actuates the closing of the air baffles 38 when precipitation is detected to be present on the road surface in front of the vehicle and may re-open the air baffles when precipitation is determined to no longer be present on the road surface.

The controller 26 may further control the actuation of a wireless communication device 39 for autonomously communicating the wet pavement condition to other vehicles utilizing a vehicle-to-vehicle or vehicle-to-infrastructure communication system.

The advantage of the techniques described herein is that no excitations are required from the vehicle or driver for initiating a determination of whether water or precipitation is present. That is, prior techniques require some considerable excitation by the vehicle whether by way of a braking maneuver, increased acceleration, steering maneuver so as for surface water detection. Based on the response (e.g., wheel slip, yawing), such a technique determines whether the vehicle is currently driving on water or precipitation. In contrast, the techniques described herein provide an anticipatory or look-ahead analysis so as to leave time for the driver or the vehicle to take precautionary measures prior to the vehicle reaching the location of the water or precipitation.

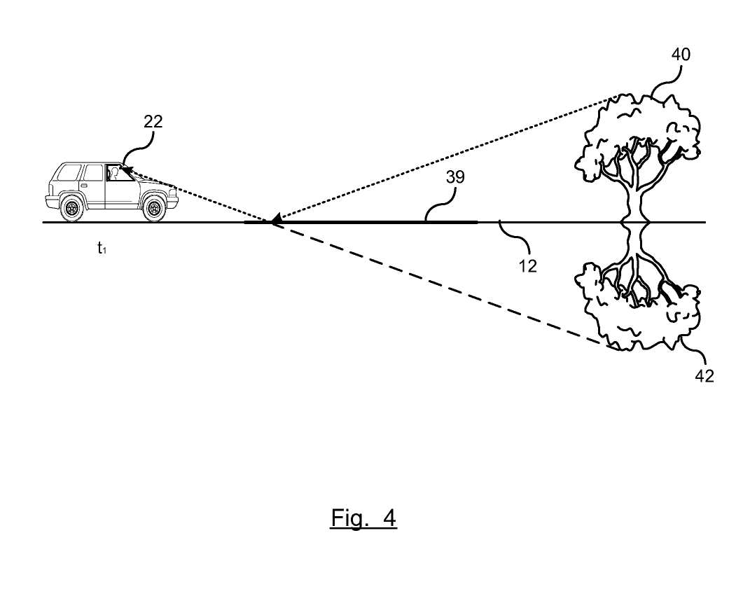

FIG. 4 illustrates pictorial illustration of how reflective properties may be used to determine whether the water is present on the surface of the traveled road utilizing a mirrored image technique. As shown in FIG. 4, at time t₁ the image capture device 22 captures the road of travel 12. Still water 39 is present on the road surface and a reflection of a real object 40 is captured in the image by the image capture device 22. The still water 39 on the road functions as a mirror-type surface having reflective properties. A light reflection on the road surface for a still water surface will have an incident light angle that is substantially equal to the reflected light angle. Furthermore, the size of the real object 40 in the image will be substantially equal to the size of a virtual object 42 in the reflections. Similarly, the distance to the real object 40 will be substantially equal to the distance to the virtual object 42 in the reflection. Since the image capture device 22 is essentially capturing an image through a mirror surface, the virtual object 42 will be inverted in reference to the real object 40 when the image is viewed. As shown in FIG. 4, the object is displayed as a virtual image below the ground having substantially the same dimensions as the real object above the ground except that the object is flipped.

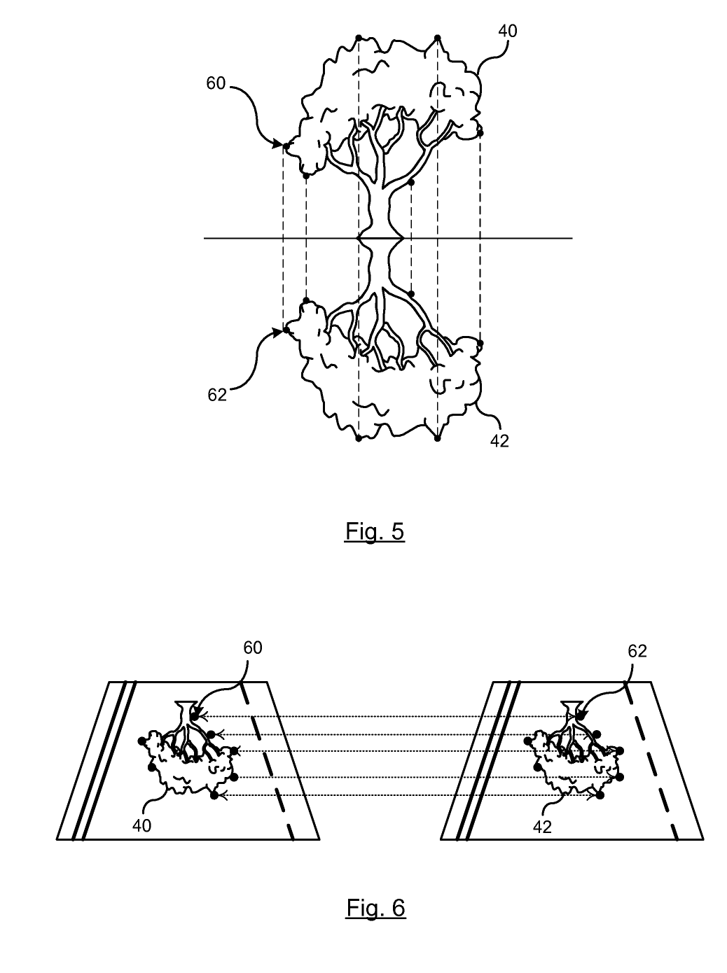

To determine whether water is present on the road of travel, real objects are compared to virtual objects. Referring to FIG. 5, the real object 40 in the image is differentiated from the virtual object 42 in the image. This is initiated by scanning the image to find two identical objects in the image that are substantially vertical to one another. That is, the virtual object 42 should be substantially vertically displaced from the real object 40. Identifying a vertical displacement of the virtual object differentiates other real objects that are identical in the real image. For example, if headlamp of a vehicle were utilized as the detected object, and if vertical displacement criteria were not utilized, the other headlamp of the real object could be viewed as a matching feature. As a result, there must be some degree of vertical displacement between the real object 40 and the virtual object 42 for determining a wet surface when detecting two identical objects.

In FIG. 5, extracted features from the real object 40 are compared with extracted features from a respective virtual object 41. If a correlating feature between the real image and the virtual image match, then a determination is made that the virtual object 41 is a reflection of the real object 40 and that water is present. In addition, the technique described herein may utilize a predetermined number of extracted features that must match for determining that water is present. As illustrated in FIG. 5, a plurality of feature points 60, are identified on the real object 40 in the captured image. A plurality of feature points 62 are identified on the virtual object 42 in the captured image. Feature points identified on the real object and virtual object are compared. If the respective feature points of the real object and the virtual object match, then a determination is made that there is a reflective surface and water is present on the road. The determination of whether the feature points match may include techniques including, but not limited to, Scale-Invariant Feature Transform (SIFT) and Speeded Up Robust Features (SURF). The threshold of the number of matching points for determining the object/image match could be a varying number relying on the information of the total number of matched point pairs and the total number of detected feature point pairs.

FIG. 6 illustrates an alternative embodiment for determining water on the road surface. In contrast to determining whether a vertical displacement is present between extracted features of the virtual object 41 and the extracted features of the real object 40, the identified real object 40 of the captured image is flipped (i.e., inverted) so as to orient the real object in a same orientation as the virtual object 41. Once the real object 40 is flipped, the vertical displacement analysis is not required. Rather, only a direct comparison performed on the extracted features of both objects is used which includes determining whether the extracted features are identical and are positioned at substantially a same location between the virtual image and the flipped real image. Feature points 60 of the real object 40 and feature points 62 of the virtual object 42 are extracted. A comparison is made between the extracted feature points of the flipped real object 40 and the virtual object 42. If the comparison of the feature points of the flipped real object and the virtual object match, then the determination is made that the virtual object was captured through a reflective surface and that water or precipitation exists on the surface of the road. Alternatively, the virtual object may be flipped for direct comparison with the true orientation of the real object.

Depending on the water/wet surface size and vehicle driving speed, the specular reflection effect from the mirror like water/wet surface may present in several continuous video frames. The aforementioned method is applied on each frame and output a detection result for each frame. An alternative decision making strategy could be based on the multiple detection results obtained from temporal multiple video frames. For example, a smoothing/averaging method or a voting method may increase the detection confidence and decrease the detection error or noise.

In response to the determination that water or precipitation is present on the surface of the road, the processor communicates with respective subsystems to mitigate the effect the water may have on the vehicle as discussed earlier. This comparison technique utilizing a flipped real object, or flipped virtual object, may be performed as the vehicle travels along the driven road. The sampling at which the images are obtained may be periodically or random.

While certain embodiments of the present invention have been described in detail, those familiar with the art to which this invention relates will recognize various alternative designs, filtering process and embodiments for practicing the invention as defined by the following claims.

What is claimed is:

1. A method for determining a wet road surface condition for a vehicle driving on a road, the method comprising the steps of:
capturing an image exterior of the vehicle by an image capture device;
detecting a real object in the captured image;
identifying a feature point on the real object in the captured image;
identifying a potential virtual object associated with the real object on a ground surface of the road in the captured image;
identifying a feature point on the virtual object in the captured image;
comparing the feature point detected on the real object with the feature point detected on the virtual object;
determining that the ground surface includes a mirror effect reflective surface in response to the feature point detected on the real object matching the feature point detected on the virtual object; and
generating a wet driving surface indicating signal in response to the determination that the ground surface includes a mirror effect reflective surface.

2. The method of claim 1 wherein the step of identifying a feature point on the real object comprises the step of identifying a plurality of feature points on the real object in the captured image.

3. The method of claim 2 wherein the step of identifying a feature point on the virtual object comprises the step of identifying a plurality of feature points on the virtual object in the captured image.

4. The method of claim 3 wherein the step of comparing the feature point detected of the real object with the feature point detected in on the virtual object comprises the step of comparing the plurality of feature points detected on the real object with the plurality of feature points detected on the virtual object.

5. The method of claim 4 wherein the step of determining that the ground surface includes a mirror effect reflective surface in response to the feature point detected on the real object matching the feature point detected on the virtual object comprises the step of determining the ground surface includes a mirror effect reflective surface in response to determining that each of the plurality of feature points detected on the real object match the plurality of feature points detected on the virtual object.

6. The method of claim 4 wherein the step of determining that the ground surface includes a mirror effect reflective surface in response to the feature point detected on the real object matching the feature point detected on the virtual object comprises the step of determining the ground surface includes a mirror effect reflective surface in response to determining that a majority of the plurality of feature points detected on the real object match the plurality of feature points detected on the virtual object.

7. The method of claim 4 wherein the step of determining that the ground surface includes a mirror effect reflective surface in response to the feature point detected on the real object matching the feature point detected on the virtual object comprises the step of determining the ground surface includes a mirror effect reflective surface in response to determining that a respective number of the plurality of feature points detected on the real object match the plurality of feature points detected on the virtual object, wherein the determination of the respective number is based on a total number of matched point pairs and a total number of detected feature point pairs.

8. The method of claim 4 wherein each respective identified feature point on the virtual object is substantially vertical to associated identified feature point on the real object.

9. The method of claim 1 wherein the identified feature point on the virtual object is substantially vertical to the identified feature point on the real object.

10. The method of claim 1 wherein one of the real object or virtual object is inverted to a substantially same position as the other of the virtual object or real object for comparing the feature point detected on the real object with the feature point detected on the virtual object.

11. The method of claim 10 wherein the steps of identifying a feature point on the real object and a feature point on the virtual image comprises the step of identifying a plurality of feature points on the real object in the captured image and a plurality of feature points on the virtual object.

12. The method of claim 11 wherein the step of comparing the feature point detected of the real object with the feature point detected in on the virtual object comprises the step of comparing the plurality of feature points detected on the real object with the plurality of feature points detected on the virtual object.

13. The method of claim 12 wherein the step of determining that the ground surface includes a mirror effect reflective surface in response to the feature point detected on the real object matching the feature point detected on the virtual object comprises the step of determining the ground surface includes a mirror effect reflective surface in response to determining that each of the plurality of feature points detected on the real object match the plurality of feature points detected on the virtual object.

14. The method of claim 12 wherein the step of determining that the ground surface includes a mirror effect reflective surface in response to the feature point detected on the real object matching the feature point detected on the virtual object comprises the step of determining the ground surface includes a mirror effect reflective surface in response to determining that a majority of the plurality of feature points detected on the real object match the plurality of feature points detected on the virtual object.

15. The method of claim 12 wherein the step of determining that the ground surface includes a mirror effect reflective surface in response to the feature point detected on the real object matching the feature point detected on the virtual object comprises the step of determining the ground surface includes a mirror effect reflective surface in response to determining that a respective number of the plurality of feature points detected on the real object match the plurality of feature points detected on the virtual object, wherein the determination of the respective number is based on a total number of matched point pairs and a total number of detected feature point pairs.

16. The method of claim 1 wherein the wet driving surface indicating signal is used to alert a driver of a potential reduced traction between vehicle tires and the road surface.

17. The method of claim 1 wherein the wet driving surface indicating signal is used to notify a driver to reduce a vehicle speed.

18. The method of claim 1 wherein the wet driving surface indicating signal is used to notify a driver to avoid evasive driving.

19. The method of claim 1 wherein the wet driving surface indicating signal is used to warn a driver of the vehicle against a use of cruise control.

20. The method of claim 1 wherein the wet driving surface indicating signal is provided to a wireless communication system for alerting other vehicles of the wet road surface condition.

21. The method of claim 1 wherein the wet driving surface indicating signal is used to warn a driver to maintain a greater following distance to a vehicle forward of the driven vehicle.

22. The method of claim 1 wherein the wet driving surface indicating signal is provided to a vehicle controller for shutting baffles on an air intake scoop of a vehicle for preventing water ingestion.

23. The method of claim 1 wherein the wet driving surface indicating signal is provided to a vehicle controller, the controller autonomously actuating vehicle braking for mitigating condensation build-up on vehicle brakes.

24. The method of claim 1 wherein multiple temporal images are analyzed for detecting whether the ground surface includes the mirror effect reflective surface for each temporal image captured, and wherein each detection result for each captured image is utilized cooperatively to generate a confidence level of whether the ground surface includes a mirror effect reflective surface.

25. The method of claim 24 wherein cooperatively utilizing each detection result to generate the confidence level is performed by averaging the detection results from the multiple temporal images.

26. The method of claim 24 wherein cooperatively utilizing each detection result to generate a confidence level is performed by a multi-voting technique of the detection results from the multiple temporal images.
